(19) United States
(12) Patent Application Publication
(10) Pub. No.: US 2006/0092819 A1
(43) Pub. Date: May 4, 2006

(54) RITE-ONCE HIGH DENSITY OPTICAL INFORMATION RECORDING MEDIUM

(76) Inventors: Ru-Lin Yeh, Hsinchu Hsien (TW); Bing-Mau Chen, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,853

(22) Filed: Nov. 1, 2005

(30) Foreign Application Priority Data
Nov. 2, 2004 (TW) 93133315

(51) Int. Cl. G11B 7/24

(52) U.S. Cl. 369/275.1

(57) ABSTRACT

A write-once high density optical information recording medium, with the recording medium made of a material having a formula of AₓB_{y}C_{z}, is formed by a special thin film coating process. There is a good contrast for optical reflectivity between the recorded marks and the non-recording areas, and the recorded marks can not be removed to be rewritten. The write-once high density optical information recording medium is easier to manufacture and is suitable for mass-production. And, the write-once high density optical information recording medium has good recording characteristics under blue laser wavelength, so that the data quality is improved remarkably and the data jitter is reduced. The multiple-layer film structure of the storage medium on the substrate of the optical disc includes a first protective layer, a recording layer, a second protective layer, and a reflective layer covering the second protective layer.

### CROSS-REFERENCE TO RELATED APPLICATION

This application claims the priority benefit of Taiwan application serial no. 93133315, filed on Nov. 2, 2004. All disclosure of the Taiwan application is incorporated herein by reference.

### BACKGROUND OF THE INVENTION

1. Field of Invention

The present invention relates to a recording medium. More particularly, the present invention relates to a write-once high density optical information recording medium.

2. Description of Related Art

People have higher and higher requirements for audio & video quality in pace with the high-tech developments. Along with recent developments in high definition digital TV, the demand for the storage media has increased, which also correspondingly stimulated the development of the high density optical information recording medium. The optical information recording medium has been developed from the earlier compact disc (CD) already to the current digital versatile disc (DVD). The storage capacity of the single side & single layer DVD is up to 4.7GB, which is several times that of the storage capacity of the 650 MB CD. But the image quality of DVD can only be up to 720×480i (SDTV). For the requirements of HDTV having 1280×720i or 1920×1080i resolution, a 135-minute film may need a storage volume of about 20GB if the image is compressed in MPEG2 mode. Therefore, the current DVD-5 (4.7 GB) and DVD-9 (8.5 GB) are not able to meet the aforementioned requirement. It is an inevitable trend for developing a new generation of blue laser high density storage optical disc, in which the write-once optical disc is the focus for development.

The recording material of the earlier write-once optical information recording medium is mainly based on organic dye. However, due to the issues such as that the organic dye is expensive, difficulty in formulation development, sensitivity to laser wavelength, high degree of complexity in organic dye solution systems, lacking in environmental tolerance (with respect to temperature and humidity), short storage life, and environmental pollution problems, many companies are dedicated to improving the storage medium, and are hoping for breakthroughs. For example, the technology of forming the recorded marks by irreversible phase transition is disclosed in U.S. Pat. No. 4,960,680, in which the material used is Sb—In—Sn, Sn—Sb—Se/Sb—Bi, and disclosed in U.S. Pat. No. 4,624,914, in which the material used is Pd—TeOx, Ni—NiOx. The technology of forming the recorded marks by gas expansion is disclosed in U.S. Pat. No. 5,401,609, in which the material used is AgOx, FeNx, CuNx, and SnNx. All the aforementioned technologies use inorganic material as recording layer for the write-once optical information recording medium. Compared with organic dye, the inorganic material has advantages such as a simpler manufacturing process, reduced environmental pollution, and higher light and environmental durability. The inorganic material used in the present invention is also easier for manufacture and is suitable for mass production.

### SUMMARY OF THE INVENTION

In response to the aforementioned disadvantages of the current storage medium which can not meet actual requirements, the present invention provides a recording medium, which in particular is directed to provide a write-once high density optical information recording medium formed by a special thin film coating process using a special storage medium structure and material having the formula of AₓB_{y}C_{z}. In addition, the write-once high density optical information recording medium has very good recording characteristics for the blue laser optical disc, so that the data quality is improved remarkably and the data jitter is reduced. In which, an element A includes one of Sn or Si; an element B includes one of Al, Ag, Au, Co, Cu, Cr, Zn, Ti, Ni, Ta, Fe, W, V, Ga, Pb, Mo, In, or Sb; an element C includes O, N, etc. x, y, and z are the atomic ratios of the elements A, B, and C; in which, x is between the range of 0 and 1.0; y is between the range of 0.02 and 0.8; z is between the range of 0 and 1.0. The multiple-layer film structure of the storage medium disposed on the substrate of the optical disc includes a first protective layer, a recording layer, a second protective layer, and a reflective layer covering the second protective layer.

Another objective of the present invention is to provide an inorganic write-once material which is more advantageous than the phase-change write-once material, such as lower reaction temperature and more noticeable difference of optical reflectivity ratio. It also has no need for complex control for the gas expansion recording mechanism.

The write-once storage medium according to the present invention is formed by a special thin film coating process using material formulation of AxByCz and a special storage medium structure. There is good contrast of the ratio of optical reflectivity between the recorded marks and non-recorded area after and before recording. In addition, the aforementioned process is irreversible. Another objective of the present invention is for providing a recording medium which is simpler for manufacture, easier for mass production, and suitable for the development of blue laser optical disc.

To make clearer the aforementioned objectives, features, and advantages of the present invention, embodiments accompanied by figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1E are respectively illustrating a plurality of partial cross-sectional views of various structures of a high density optical information recording medium of the present invention.

FIG. 2 is a schematic diagram illustrating the structure of the apple pie target.

FIG. 3A is a charge coupled device camera photo image view of a testing disc with different duration time of the recording laser pulse ranged from 20 ns to 70 ns, according to the first embodiment of the present invention.

FIG. 3B is a relationship diagram of the reflectivity voltage of the testing disc with respect to the time before and after the recording process while the duration time of the recording laser pulse is ranged from 20 ns to 70 ns, according to the first embodiment of the present invention.

FIG. 4 is a dynamic eye pattern of DVD 3T-14T of the testing disc, according to the first embodiment of the present invention.

FIG. 5A is a relationship diagram of the mark jitter of the testing disc to the gas flow of oxygen, according to the second embodiment of the present invention.

FIG. 5B is a dynamic eye pattern of the blue laser 2T-11T of the testing disc, according to the second embodiment of the present invention.

FIG. 5C is a schematic diagram of the mark jitter histogram of the testing disc, according to the second embodiment of the present invention.

FIG. 6A is a relationship diagram of the mark jitter of the testing disc to the gas flow of N₂, according to the third embodiment of the present invention.

FIG. 6B is a dynamic eye pattern of the blue laser 2T-11T of the testing disc, according to the third embodiment of the present invention.

FIG. 6C is a schematic diagram of the mark jitter histogram of the testing disc, according to the third embodiment of the present invention.

### DESCRIPTION OF EMBODIMENTS

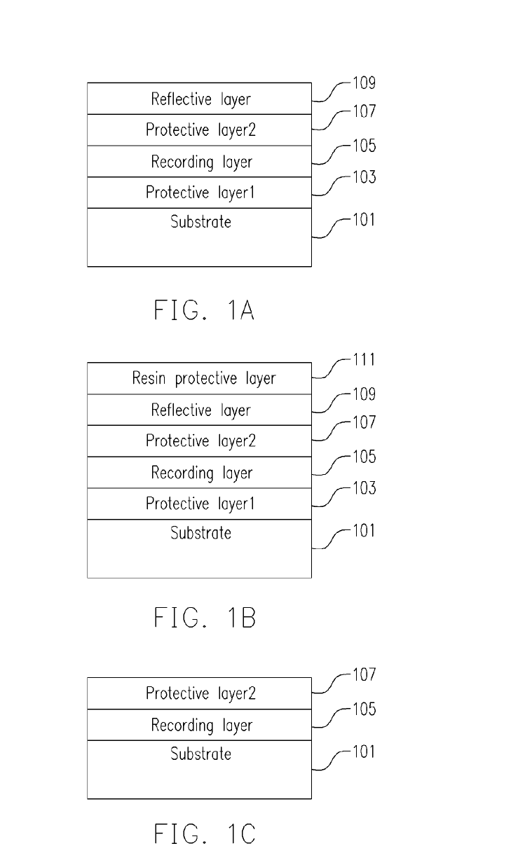

FIG. 1A to FIG. 1E are respectively partial cross-sectional views of the various structures which are used as the write-once high density optical information recording medium of the present invention. In FIG. 1A to FIG. 1E, the same reference numerals indicate identical or functionally similar elements, thus the description is omitted.

Referring to FIG. 1A, the present invention provides a write-once high density optical information recording medium, in which the structure of the optical disc mainly includes a substrate 101, a first protective layer 103, an inorganic material recording layer 105, a second protective layer 107, and a reflective layer 109.

The substrate 101 includes a transparent substrate with a signal surface, for example, a write-once optical disc substrate, or a write-once digital versatile disc substrate. The material is, for example, glass, Polycarbonate (PC), Polymethylmethacrylate (PMMA) or Metallocene Catalyzed Cyclo Olefin Copolymer (MCOC), etc.

The first protective layer 103 is disposed on the substrate 101. It is composed of dielectric materials, such as SiNₓ, SiOₓ, ZnS—SiO₂, AlNₓ, SiC, GeNₓ, TiNₓ, TaOₓ, YOₓ, etc. The thickness of the first protective layer 103 is, for example, between 0 nm and 100 nm. The first protective layer 103 includes a single dielectric material layer or composite dielectric material layers having more than one layer of dielectric material layer.

The inorganic material recording layer 105 is disposed on the first protective layer 103, and the material of the inorganic material recording layer 105 includes the material as shown in the following chemical formula (I): AₓB_{y}C_{z} (I), where the element A includes at least one of Si and Sn; the element B includes at least one of Al, Ag, Au, Zn, Ti, Ni, Cu, Co, Ta, Fe, W, Cr, V, Ga, Pb, Mo, In and Sb; and the element C includes at least one of O and N; where x, y and z represent the atomic ratios of the element A, B and C, respectively; x is ranged from 0 to 1.0; y is ranged from 0.02 to 0.8; z is ranged from 0 to 1.0. The thickness of the inorganic material recording layer 105 is, for example, between 0 and 80 nm. After the inorganic material recording layer 105 is heated by the irradiation of the laser light source, part of the inorganic material recording layer 105 may absorb the heat to form a recorded mark with a phenomenon of reflectivity change.

The second protective layer 107 is disposed on the inorganic material recording layer 105. It is composed of dielectric materials, such as SiNₓ, SiOₓ, ZnS—SiO₂, AlNₓ, SiC, GeNₓ, TiNₓ, TaOₓ, YOₓ, etc. The thickness of the second protective layer 107 is, for example, between 5 nm and 100 nm. The second protective layer 107 includes a single dielectric layer or composite dielectric layers having more than one dielectric layer.

The reflective layer 109 is disposed on the second protective layer 107. The material of the reflective layer 109 is, for example, Au, Ag, Al, Ti, Pb, Cr, Mo, W, Ta or an alloy of above materials. The thickness of the reflective layer 109 is, for example, between 0 nm and 200 nm.

As further illustrated in FIG. 1B, the optical disc structure of high density information recording medium can include a resin protective layer 111 which is formed above the reflective layer 109. The resin protective layer 111 is, for example, a photocurable resin.

The structure of the write-once high density optical information recording medium, as illustrated in FIG. 1C, can exclusively include the substrate 101, the inorganic material recording layer 105, and the second protective layer 107. Or as illustrated in FIG. 1D, the structure of the write-once high density optical information recording medium can include the substrate 101, the inorganic protective layer 105, the second protective layer 107, and the reflective layer 109. Or as shown in FIG. 1E, the structure of the write-once high density optical information recording medium can include the substrate 101, the first protective layer 103, the inorganic protective layer 105, and the second protective layer 107.

The present invention replaces the organic dye with the inorganic material as the recording layer of the high density optical information recording medium. As the inorganic material has advantages such as higher light-resistance and environmental durability than the organic dye, the lifespan of the high density optical information recording medium is extended. Moreover, the inorganic material has lower cost than the organic dye, and there is no need for the organic solvent; therefore, the manufacturing cost is lowered and less environmental pollution is occurred. In addition, the high density optical information recording medium can have high recording density by using the inorganic material as the recording layer in cooperation with the land/groove recording method. Therefore, the various aforementioned optical disc structures of the present invention can be applied in write-once compact disc-recordable (CD-R), write-once digital versatile disc-recordable (DVD-R), write-once blue laser digital versatile disc and write-once blue laser information recording medium, and multiple recording layers optical disc.

According to the recording theory of the write-once high density optical information recording medium in the present invention, the laser beam, passing through the substrate 101, is focused on the inorganic material recording layer 105. And the inorganic material recording layer 105 absorbs the heat from pulse high power of laser beam forming the recorded marks. As a result, high reflectivity difference between the recorded marks and non-recorded area can be obtained. The reaction is irreversible, so that the inorganic material recording layer 105 is suitable to be applied to write-once high density optical information recording medium in cooperation with thin film design.

The above describes the structure of the write-once high density optical information recording medium. The following is for illustrating the manufacturing method of the write-once high density optical information recording medium of the present invention with reference to the structure in FIG. 1A.

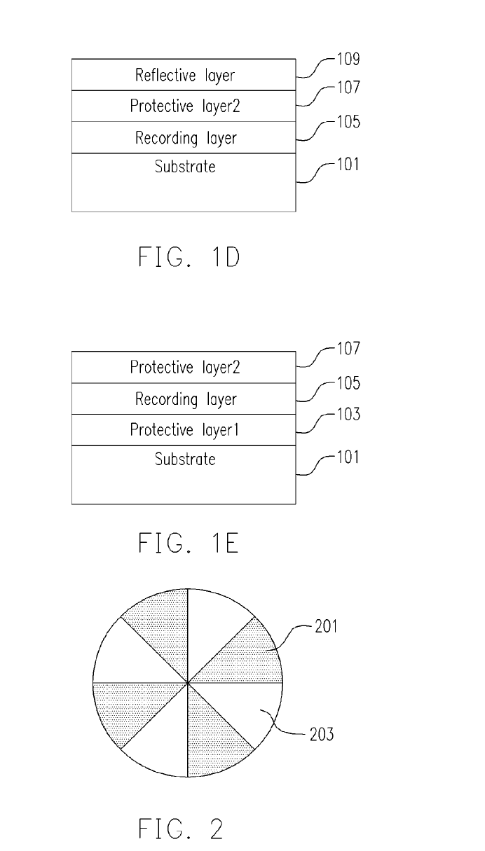

The inorganic material recording layer 105 is disposed on the first protective layer 103, and the material of the inorganic material recording layer 105 includes the material as shown in formula (I): AₓB_{y}C_{z} (I). The method of forming the inorganic material recording layer 105 includes (1)co-sputtering, (2)alloy sputtering method and (3)apple pie target sputtering method. If the element A and the element B are two independent sputtering targets, and the element C is added into the sputtering process, the method is called co-sputtering method. If the element A and the element B are mixed to form an alloy sputtering target and the element C is added into the sputtering process, the method is called alloy target sputtering method. If the element A and the element B are formed into a sputtering target via interlaced arrangement, as shown in FIG. 2, where the reference numeral 201 represents the element A and the reference numeral 203 represents the element B, and the element C is added into the sputtering process, the method is called apple pie target sputtering method. The atomic ratio of the element A and the element B in the inorganic material recording layer 105 can be adjusted by the applied power on the element A target and the element B target in co-sputtering method, or by the composition of the element A and the element B of the alloy target in alloy target sputtering method, or by the area ratio of the element A and the element B of the apple pie target in the apple pie target sputtering method. The quantity of the element C can be controlled by the gas flow of oxygen or nitrogen. The material of the substrate 101 is polycarbonate (PC). The first protective layer 103 is formed on the substrate 101 by the method of, for example, co-sputtering or coating method. The inorganic material recording layer 105 is formed on the first protective layer 103. Then, the second protective layer 107 is formed on the inorganic material recording layer 105. The method of forming the second protective layer 107 is, for example, co-sputtering or coating method. Thereafter, the reflective layer 109 is formed on the second protective layer 107, and the method of forming the reflective layer 109 is, for example, sputtering.

The structure of AₓB_{y}C_{z} in the present invention can be formed by the methods described in the thin film coating process. Good results can be obtained within the blue laser optical disc specification. Accordingly, the data quality is remarkably improved and the data jitter is reduced. In the manufacturing methods, the present invention provides the following three embodiments to describe the structure and the manufacturing process of the multiple-sputtered layers.

EMBODIMENT 1, in which the structure of the multiple-layer film of which is as follows:

1.1A protective layer (ZnS—SiO₂) is formed on the DVD substrate (with track pitch of 0.74 μm) by sputtering;

1.2An inorganic material recording layer (SiₓAl_{y} alloy) is formed on the protective layer;

1.3Then, a protective layer (ZnS—SiO₂) is formed on the inorganic material recording layer, and a reflective layer (AlTi) is formed on the protective layer;

2.1EMBODIMENT 2, in which the multiple-layer structure of which is as follows:

2.1 A protective layer (ZnS—SiO₂) is formed on the optical disc substrate (with track pitch of 0.4 μm) by sputtering;

2.2An inorganic material recording layer (SiₓAl_{y}O_{z} alloy) is formed on the protective layer;

2.3 Then, another protective layer (ZnS—SiO₂ with thickness of 5 nm-100 nm) is formed on the inorganic material recording layer, and a reflective layer (Ag) is formed on the protective layer;

The recording characteristics can be remarkably improved by adjusting the gas flow of O₂ in the sputtering process of the recording layer of the present invention.

EMBODIMENT 3, in which the structure of the multiple layer film of which is as follows:

3.1 A protective layer (ZnS—SiO₂) is formed on the optical disc substrate (with track pitch of 0.4 μm) by sputtering;

3.2 An inorganic material recording layer (SiₓAl_{y}N_{z} alloy) is formed on the protective layer;

3.3 Then, a protective layer (ZnS—SiO₂) is formed on the inorganic material recording layer, and a reflective layer (Ag) is formed on the protective layer;

The recording characteristics can be remarkably improved by adjusting the gas flow of N₂ in the sputtering process of the recording layer of the present invention.

The protective layer, the recording layer, and the reflective layer of the write-once high density optical information recording medium of the present invention can be formed by consecutive sputtering process, hence the manufacturing process is relatively simple.

In order to verify the recording characteristics of the high density optical information recording medium according to the present invention, the testing discs are made according to the first embodiment to the third embodiment by the aforementioned manufacturing methods. Then, static test for the testing disc of the first embodiment is performed, and dynamic test for the testing discs corresponding to the first embodiment to the third embodiment are performed. The present invention is not limited within the contents of the first embodiment to the third embodiment.

Manufacturing Process of the Testing Disc

The following is for describing the manufacturing process of the testing discs in detail.

The manufacturing process of the testing disc of the first embodiment is as the following: in the first embodiment, a protective layer (ZnS—SiO₂ with thickness of 5-50 nm) is formed on the DVD substrate (with track pitch of 0.74 μm) by sputtering in the manufacturing process of the multiple-layer structure. Then, an inorganic material recording layer (SiₓAl_{y} with thickness of 3-80 nm) is formed on the protective layer. Later, a protective layer (ZnS—SiO₂ with thickness of 5-50 nm) is formed on the inorganic material recording layer. And a reflective layer (AlTi with thickness of 60-120 nm) is formed on the protective layer. Accordingly, the testing disc according to the first embodiment is completed.

The manufacturing process of the testing disc of the second embodiment is as the following: in the second embodiment, a protective layer (ZnS—SiO₂ with thickness of 5-100 nm) is formed on the optical disc substrate (with track pitch of 0.4 μm) by sputtering in the manufacturing process of the multiple-layer structure. Then, an inorganic material recording layer (SiₓAl_{y}O_{z} with thickness of 3-80 nm) is formed on the protective layer. Later, a protective layer (ZnS—SiO₂ with thickness of 5-100 nm) is formed on the inorganic material recording layer, and a reflective layer (Ag with thickness of 50-200 nm) is formed on the protective layer. The gas flow of O₂ is changed from 0 to 2.5 sccm and the gas flow of Ar is at 10 sccm in the manufacturing process of the optical disc. Accordingly, the testing disc according to the second embodiment is completed.

The manufacturing process of the testing disc of the third embodiment is as the following: in the third embodiment, a protective layer (ZnS—SiO₂ with thickness of 5-100 nm) is formed on the optical disc substrate (with track pitch of 0.4 μm) by sputtering in the manufacturing process of the multiple-layer structure. Then, an inorganic material recording layer (SiₓAl_{y}N_{z} with the thickness of 3-80 nm) is formed on the protective layer. Later, a protective layer (ZnS—SiO₂ with the thickness of 5-100 nm) is formed on the inorganic material recording layer, and a reflective layer (Ag with the thickness of 50-200 nm) is formed on the protective layer. The gas flow of N₂ is changed from 0 to 2.5 sccm and the gas flow of Ar is at 10 sccm in the manufacturing process of the optical disc. Accordingly, the testing disc according to the third embodiment is completed.

Experimental Result of the Testing Discs

Measurement for the testing disc of the first embodiment is performed using the static test apparatus (made by the Toptica company, Model: Media test-1). Marks on the testing disc are recorded by the static test device using one semiconductor red laser diode (wavelength 659 nm) under single pulse mode and monitored by another semiconductor laser diode (wavelength 633 nm) under continuous wave mode. That is, the inorganic material recording layer is irradiated by single laser pulses with different red laser power (mW) and duration time (ns), and the optical properties are measured by continuous laser wave to sow the difference in reflectivity between the recorded mark and non-recorded area throughout the process in which the reflectivity difference is converted to voltage signal to measure the time for the phase conversion. And the recording process is also viewed corresponding to each condition using the charge coupling device (CCD) camera photo image. In which, the recording power of the static test device is 12 mW, and the duration time of the recording pulse is between 20 ns and 70 ns.

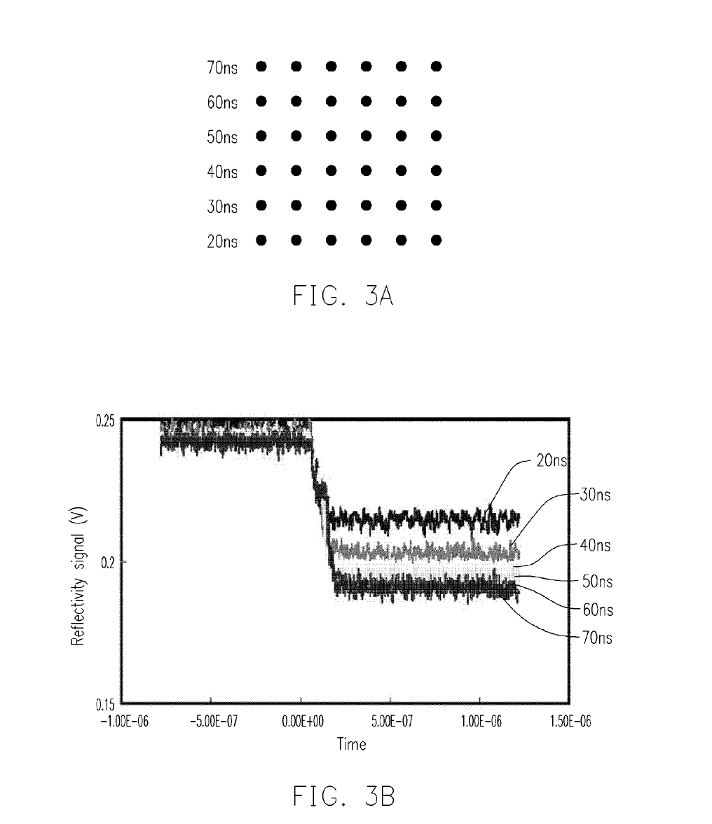

FIG. 3A is the image view of the marks on the testing disc of the first embodiment captured by a charge coupled device (CCD) camera with the pulse duration ranged from 20 to 70 ns, and FIG. 3B is a relationship diagram of the reflectivity voltage of the testing disc with respect to the time before and after the recording process while the duration time of the laser pulse is ranged from 20 to 70 ns. It can be learned from the results of FIG. 3A and FIG. 3B that, when the material of the recording layer is SixAly alloy, marks can be recorded with adequate pulse power and short duration time. Therefore, it can be a write-once high density optical information recording medium.

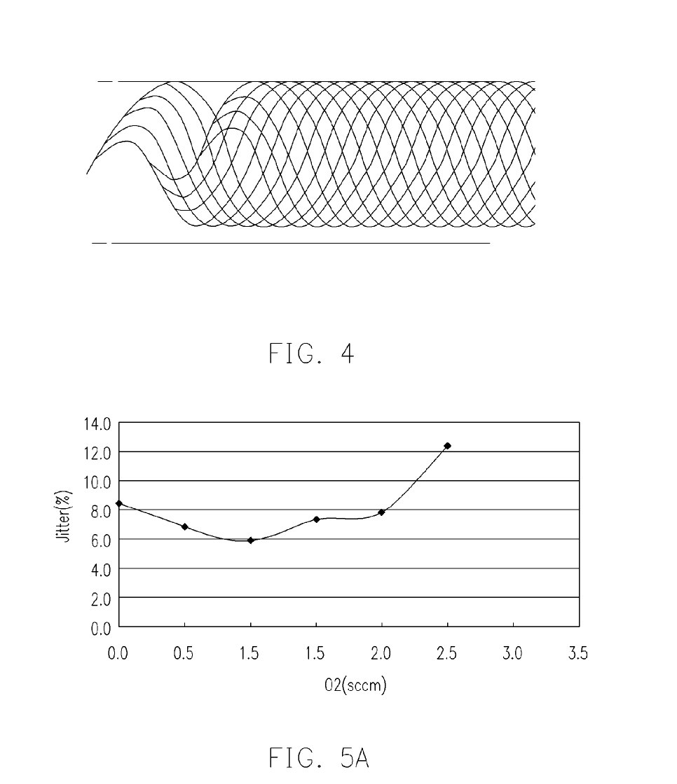

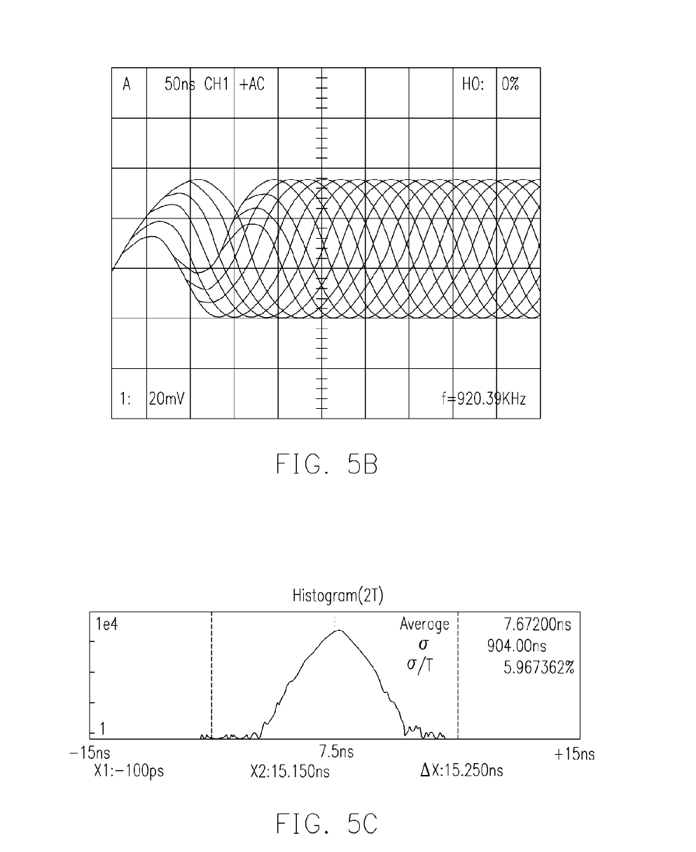

FIG. 4 is a dynamic eye pattern of DVD 3T-14T of the testing disc according to the first embodiment of the present invention, in which the optical disc dynamic test device used is made by Plustec and the model is DDU-1000. In addition, the recording condition is at DVD 2.4×speed(8.4 m/s) and the recording modulation code is RLL(2,10). The mark jitter of the testing disc is about 7.3% and is in compliance with the dynamic recording specification of DVD optical disc.

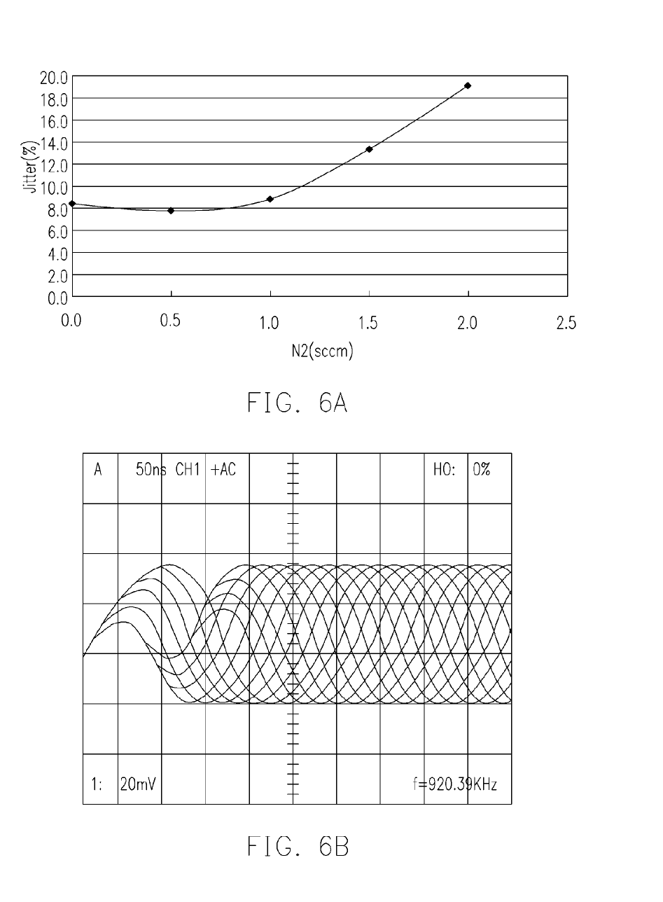

The blue laser optical disc dynamic test device used to measure the optical disc of the second embodiment is made by Shibasoku and the model is LM 330A. The recording modulation code is RLL(1,10); the channel clock frequency is 66 MHz; and the recording linear velocity is 8.25 m/s. FIG. 5A is a relationship diagram of the mark jitter with respect to the gas flow of O₂ which is added during the sputtering process of the recording layer, where the gas flow of O₂ is changed from 0 to 2.5 sccm while the gas flow of Ar is at 10 sccm. The mark jitter of the optical disc varies with the gas flow of O₂. For example, the mark jitter of the optical disc is reduced to be lower than 6% when the gas flow of O₂ is at 1 sccm. Therefore, adjusting the gas flow of O₂ in the sputtering process of the recording layer could improve the recording characteristics remarkably.

FIG. 5B shows the dynamic eye pattern of the optical disc of the second embodiment with good symmetry and FIG. 5C indicates that the testing disc of the second embodiment has the mark jitter of 5.97% when the gas flow of O₂ is at 1 sccm. It is known from the testing results that the testing disc of the second embodiment has good recording characteristics.

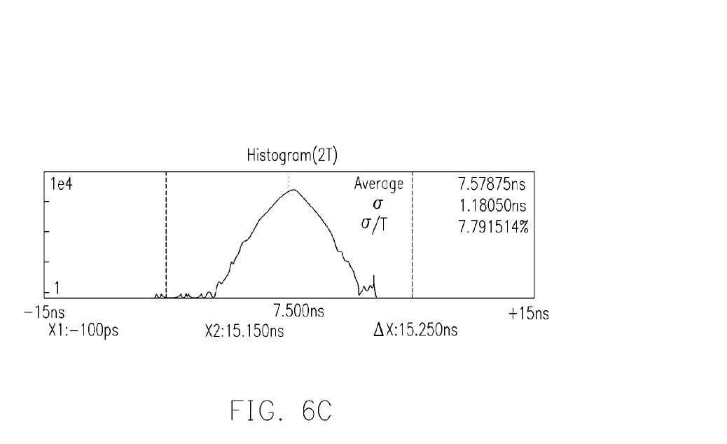

The blue laser optical disc dynamic test device used to measure the optical disc of the third embodiment is made by Shibasoku and the model is LM 330A. The recording modulation code is RLL(1,10); the channel clock frequency is 66 MHz; and the recording linear velocity is 8.25 m/s. FIG. 6A is a relationship diagram of the mark jitter with respect to the gas flow of N₂ which is added during the sputtering process of the recording layer. The gas flow of N₂ is changed from 0 to 2.5 sccm and the mark jitter is below 8% when the gas flow of N₂ is at 0.5 sccm.

FIG. 6B shows the dynamic eye pattern of the optical disc of the third embodiment which has good symmetry and FIG. 6C shows the mark jitter of 7.58% when the gas flow of N₂ is at 0.5 sccm, which indicates that the testing disc of the third embodiment has good recording characteristics.

As learned from the results, the high density optical information recording medium of the present invention has good recording properties in red and blue laser recording system and can be easily produced using the methods of thin film sputtering process.

It is apparent to those who are skilled in the arts of manufacturing optical discs that various modification and variation can be applied to the structure of the present invention without departing from the scope or the spirit of the present invention. In view of the foregoing perspectives, it is intended that the present invention covers any modification and variation of this invention provided they fall within the scope of the following claims and their equivalents.

What is claimed is:

1. A write-once high density optical information recording medium, wherein the multiple-layer film structure of the optical disc respectively comprising: a substrate, a first protective layer, an inorganic material recording layer, a second protective layer, and a reflective layer; wherein, the material of the inorganic material recording layer includes the material as shown in chemical formula (1):
AₓB_{y}C_{z} (I)
where the element A includes at least one of Si and Sn; the element B includes at least one of Al, Ag, Au, Zn, Ti, Ni, Cu, Co, Ta, Fe, W, Cr, V, Ga, Pb, Mo, In and Sb; and the element C includes at least one of O and N; where x, y and z represent the atomic ratios of the element A, B and C, respectively; x is ranged from 0 to 1.0; y is ranged from 0.02 to 0.8; z is ranged from 0 to 1.0.

2. The write-once high density optical information recording medium in claim 1, wherein the structure further includes a resin protective layer formed on the reflective layer.

3. The write-once high density optical information recording medium in claim 1, wherein the material of the resin protective layer is a photocurable resin.

4. The write-once high density optical information recording medium in claim 1, wherein the material of the first protective layer and the second protective layer includes one of SiNₓ, SiOₓ, ZnS—SiO₂, AlNₓ, SiC, GeNₓ, TiNₓ, TaOₓ, YOₓ, respectively.

5. The write-once high density optical information recording medium in claim 1, wherein the first protective layer and the second protective layer are a dielectric material layer or a composite dielectric material layer.

6. The write-once high density optical information recording medium in claim 1, wherein the material of the reflective layer is Au, Ag, Al, Ti, Pb, Cr, Mo, W, Ta, and an alloy thereof.

7. The write-once high density optical information recording medium in claim 1, wherein the inorganic material recording layer is made of AxBy material by apple pie target co-sputtering, and element C is added in the manufacturing process to complete the AₓB_{y}C_{z} recording layer.

8. The write-once high density optical information recording medium in claim 1, wherein the manufacturing process of the inorganic material recording layer is using co-sputtering for the element A and the element B, and adding the element C in the manufacturing process to completing the formation of the AₓB_{y}C_{z} material.

9. The write-once high density optical information recording medium in claim 1, wherein the inorganic material recording layer is made of AₓB_{y}C_{z} material by sputtering using alloy target.

10. The write-once high density optical information recording medium in claim 1, wherein the substrate is a write-once digital versatile disc substrate, or a write-once optical disc substrate.

11. A write-once high density optical information recording medium, comprising: a substrate, and an inorganic material recording layer and a second protective layer disposed on the substrate in sequence; wherein, the material of the inorganic material recording layer is the material as shown in chemical formula (I):
AₓB_{y}C_{z} (I)
where the element A includes at least one of Si and Sn; the element B includes at least one of Al, Ag, Au, Zn, Ti, Ni, Cu, Co, Ta, Fe, W, Cr, V, Ga, Pb, Mo, In and Sb; and the element C includes at least one of O and N; where x, y and z represent the atomic ratios of the element A, B and C, respectively; x is ranged from 0 to 1.0; y is ranged from 0.02 to 0.8; z is ranged from 0 to 1.0.

12. The write-once high density optical information recording medium in claim 11, wherein the structure further includes a reflective layer disposed on the second protective layer.

13. The write-once high density optical information recording medium in claim 11, wherein the structure further comprising:
a first protective layer disposed between the inorganic material recording layer and the substrate.

14. The write-once high density optical information recording medium in claim 13, wherein the material of the first protective layer and the second protective layer is comprised of the following composite materials: SiNₓ, SiOₓ, ZnS—SiO₂, AlNₓ, SiC, GeNₓ, TiNₓ, TaOₓ, YOₓ.

15. The write-once high density optical information recording medium in claim 11, wherein the manufacturing process of the inorganic material recording layer includes using apple pie target sputtering for the element A and the element B, and adding the element C in the manufacturing process for completing the formation of the AₓB_{y}C_{z} material, wherein the atomic ratio of the element A and the element B is adjusted by the area of the target material.

16. The write-once high density optical information recording medium in claim 11, wherein the manufacturing process of the inorganic material recording layer is using co-sputtering for the element A and the element B, and adding the element C in the manufacturing process for completing the formation of the AₓB_{y}C_{z} material.

17. The write-once high density optical information recording medium in claim 11, wherein the manufacturing process of the inorganic material recording layer is using co-sputtering for the element A and the element B, or for the element A, the element B, and the element C for completing the formation of the AₓB_{y}C_{z} material.

18. The write-once high density optical information recording medium in claim 11, wherein the substrate is a write-once digital versatile disc substrate, or a write-once optical disc substrate.
